(19) United States
(12) Patent Application Publication
(10) Pub. No.: US 2016/0288377 A1
(43) Pub. Date: Oct. 6, 2016

(54) METHOD FOR PRODUCING COMPOSITE COMPONENTS

(71) Applicant: BAYER MATERIALSCIENCE AG, Leverkusen (DE)

(72) Inventors: Dirk PASSMANN, Oberhausen (DE); Klaus FRANKEN, Bergisch Gladbach (DE); Stefan LINDNER, Remscheid (DE)

(21) Appl. No.: 14/442,123

(22) PCT Filed: Nov. 11, 2013
(86) PCT No.: PCT/EP2013/073461

§ 371 Date: May 12, 2015

(30) Foreign Application Priority Data
Nov. 14, 2012 (EP) 12192664.6

(51) Int. Cl. B29C 43/00; F03D 1/06; C08G 18/76; C08G 18/48; C08G 18/20

(52) U.S. Cl. CPC B29C 43/003; C08G 18/4829; C08G 18/2063; C08G 18/7671; F03D 1/0675; F05B 2230/21; F05B 2280/40; B29K 2049/00; B29K 2075/00

(57) ABSTRACT

A process for the production of composite components comprising the following steps:
providing a moulding core;
bringing at least one portion of the moulding core into contact with a polyurethane/polyisocyanurate reaction mixture, where at least for some time during the contact a subatmospheric pressure p1 is applied to at least the exterior of the moulding core.

A superatmospheric pressure p2 is applied to at least the exterior of the moulding core when a time t1 has expired after beginning of the contact of the moulding core with the polyurethane/polyisocyanurate reaction mixture and/or a temperature T1 is reached in the polyurethane/polyisocyanurate reaction mixture which makes contact with the moulding core.

The present invention relates to a process for the production of composite components, comprising the following steps: provision of a moulding core and bringing at least one portion of the moulding core into contact with a polyurethane/polyisocyanurate reaction mixture, where at least for some time during the contact a subatmospheric pressure p1 is applied to at least the exterior of the moulding core.

The use of polyurethane (PUR) resin or polyisocyanurate (PIR) resin for the production of composite components, for example rotor blades for the wind energy industry, promises to provide some advantages in the technology of processes and of tooling. Among these are lower viscosity and better flow properties of the resins, and also improved fatigue performance of the resultant composite materials.

DE 10 2009 058 101 A1 describes the use of layer structures in wind turbines in which polyurethane is used as plastic. The ratio of number of isocyanate groups to number of groups reactive towards isocyanate is preferably from 0.9 to 1.5. The ratio of number of isocyanate groups to number of groups reactive towards isocyanates in the Examples carried out was about 1.02. The process has the disadvantage that the viscosity of the mixture is relatively high, and therefore the fibre layer comprising plastic is relatively difficult to produce.

WO 2011/081622 A1 describes polyurethane compositions for composite structures. The composite structures can be used for rotor blades of wind turbines. The OH/NCO ratio is at least 1, i.e. there are at least as many OH groups as NCO groups. The process has the disadvantage that the viscosity is relatively high and the processing period is very short; this makes the charging process much more difficult for large components.

However, PUR/PIR is unlike the conventional resins such as EP or UP in having the property of foaming on contact with water. This is in the first place a disadvantage, since the materials to be used for a composite core such as balsa wood and the like necessarily comprise water and therefore would require drying. This requires a relatively large amount of logistics resource, and incurs drying costs, etc. This phenomenon is additionally amplified by the use of vacuum during the infusion process when a resin-injection process such as RTM (resin transfer moulding) is carried out. However, a vacuum is necessary in order to remove included gases before the infusion process, or in order to achieve ideal positioning of a laid-scrim structure.

It is an object of the present invention to provide a process which is intended for the production of composite components and which can use polyurethane resins together with materials comprising moisture.

According to the invention, the object is achieved via a process for the production of composite components, comprising the following steps:
providing a moulding core;
bringing at least one portion of the moulding core into contact with a polyurethane/polyisocyanurate reaction mixture, where at least for some time during the contact a subatmospheric pressure p1 is applied to at least the exterior of the moulding core;
   where a superatmospheric pressure p2 is applied to at least the exterior of the moulding core when a time t1 has expired after beginning of the contact of the moulding core with the polyurethane/polyisocyanurate reaction mixture and/or a temperature T1 is reached in the polyurethane/polyisocyanurate reaction mixture which makes contact with the moulding core.

The process of the invention can be used for the production of composite components where a strong bond is produced between a moulding core and a resin. The resin here is the polyurethane/polyisocyanurate reaction mixture. It is likewise possible that a fibre composite material is produced from fibres and resin and that the moulding core serves merely for the shaping process, without entering into any bonding with the resin. Finally, it is also conceivable, as explained in detail below, that fibres or textile sheet elements are arranged on a moulding core and that the resin enters into bonding with the core and the fibres or textile sheet elements. The moulding core can also serve as means for the maintenance of a certain separation in the composite component.

It is preferable that the composite components produced are rotor blades for wind turbines.

Suitable materials for the moulding core are by way of example balsa wood, polyvinyl chloride (PVC), polyester (PET) and polyurethane (FUR). The envelope density of foamed moulding cores can be in the range from 20 kg/m³ to 600 kg/m³, preferably from 30 kg/m³ to 400 kg/m³ and more preferably from 50 kg/m³ to 200 kg/m³.

One step of the process includes bringing at least one portion of the moulding core into contact with a polyurethane/polyisocyanurate reaction mixture, where at least for some time during the contact a subatmospheric pressure p1 is applied to at least the exterior of the moulding core. The expression “subatmospheric pressure” here means an absolute pressure of less than 1013 mbar. This procedure removes problematic gases, holds the core and any fibres located on the core in place and facilitates the spread or infusion of the reaction mixture in all parts of the core.

The subatmospheric pressure is advantageously applied by means of an evacuatable mould or other structure surrounding the moulding core.

However, once the reaction of the polyurethane/polyisocyanurate reaction mixture has proceeded to a certain extent, subatmospheric pressure is no longer desirable. Formation of a polyurethane foam can occur in conjunction with residual moisture located in the moulding core or present from other sources. This obviously leads to structural defects and therefore to a composite component that cannot be used.

A superatmospheric pressure p2 is therefore applied at a certain juncture in the process. The expression “superatmospheric pressure” here means an absolute pressure of 1013 mbar or more. This superatmospheric pressure inhibits foaming, so that by way of example CO₂ that has been formed can in turn be dissolved. Available options, selection from which depends on the possibility of monitoring the course of the reaction, are to allow a predetermined waiting time t1 before applying the superatmospheric pressure or to trigger the procedure when a predetermined temperature T1 (resulting from the exothermic polyurethane reaction) is reached or exceeded. The selected time t1 and/or the selected temperature T1 depend on the shape and dimensions of the composite component to be produced, and also on the properties of the polyurethane/polyisocyanurate reaction mixture, in particular the crosslinking time or gel time.

For the purposes of the invention the expression “polyurethane/polyisocyanurate reaction mixture” means a reaction mixture which leads to polyurethanes and/or to polyisocyanurates. The NCO index here (molar ratio of NCO groups to groups reactive towards NCO) is preferably ≧0.95, more preferably from ≧1.00 to ≦6.00, still more preferably from ≧1.10 to ≦6.00.

The polyurethane/polyisocyanurate reaction mixture comprises:

A) one or more polyisocyanates

B) one or more polyols and

C) one or more crosslinking catalysts

Polyisocyanate component A) used can be the conventional aliphatic, cycloaliphatic and in particular aromatic di- and/or polyisocyanates. Examples of these suitable polyisocyanates are butylene 1,4-diisocyanate, pentane 1,5-diisocyanate, hexamethylene 1,6-diisocyanate (HDI), isophorone diisocyanate (IPDI), trimethylhexamethylene 2,2,4- and/or 2,4,4-diisocyanate, the isomeric bis(4,4′-isocyanatocyclohexyl)methanes and mixtures of these with any desired isomer content, cyclohexylene 1,4-diisocyanate, phenylene 1,4-diisocyanate, tolylene 2,4- and/or 2,6-diisocyanate (TDI), naphthylene 1,5-diisocyanate, diphenylmethane 2,2′- and/or 2,4′- and/or 4,4′-diisocyanate (MDI) and/or higher homologues (pMDI), 1,3- and/or 1,4-bis(2-isocyanatoprop-2-yl)-benzene (TMXDI), 1,3-bis(isocyanatomethyl)benzene (XDI). It is also possible to use, alongside the abovementioned polyisocyanates, a proportion of modified polyisocyanates having uretdione, isocyanurate, urethane, carbodiimide, uretonimine, allophanate or biuret structure. It is preferable to use, as isocyanate, diphenylmethane diisocyanate (MDI) and in particular mixtures of diphenylmethane diisocyanate and polyphenylene polymethylene polyisocyanate (pMDI). The preferred monomer content of the mixtures of diphenylmethane diisocyanate and polyphenylene polymethylene polyisocyanate (pMDI) is from 60 to 100% by weight, preferably from 70 to 95% by weight, particularly preferably from 80 to 90% by weight. The NCO content of the polyisocyanate used should preferably be above 25% by weight, with preference above 30% by weight, with particular preference above 32% by weight. The NCO content can be determined in accordance with DIN 53185. The viscosity of the isocyanate should preferably be ≦150 mPas (at 25° C.), preferably ≦50 mPas (at 25° C.) and particularly preferably ≦30 mPas (at 25° C.).

When a single polyol is added, the OH number gives the OH number of component B). In the case of mixtures, the number-average OH number is stated. This value can be determined by reference to DIN 53240-2. Polyols preferably present in the polyol formulation are those with number-average OH number of from 100 to 1000 mg KOH/g, preferably from 300 to 600 mg KOH/g and particularly preferably from 350 to 500 mg KOH/g. The viscosity of the polyols is preferably ≦800 mPas (at 25° C.). It is preferable that the polyols have at least 60% of secondary OH groups, with preference at least 80% of secondary OH groups and with particular preference at least 90% of secondary OH groups. Particular preference is given to polyether polyols based on propylene oxide. It is preferable that the average functionality of the polyols used is from 2.0 to 5.0, particularly from 2.5 to 3.5.

According to the invention it is possible to use polyether polyols, polyester polyols or polycarbonate polyols, preference being given to polyether polyols. Examples of polyether polyols that can be used according to the invention are the polytetramethylene glycol polyethers obtainable via polymerization of tetrahydrofuran by means of cationic ring-opening. Equally suitable polyether polyols are adducts of styrene oxide, ethylene oxide, propylene oxide and/or butylene oxides onto di- or polyfunctional starter molecules. Examples of suitable starter molecules are water, ethylene glycol, diethylene glycol, butyl diglycol, glycerol, diethylene glycol, trimethylolpropane, propylene glycol, pentaerythritol, sorbitol, sucrose, ethylenediamine, toluenediamine, triethanolamine, 1,4-butanediol, 1,6-hexanediol, and also low-molecular-weight esters of such polyols with dicarboxylic acids, where these esters have hydroxy groups; other suitable starter molecules are oils having hydroxy groups. Preference is given to glycerol as starter. The viscosity of the polyols is preferably ≦800 mPas (at 25° C.). It is preferable that the polyols have at least 60% of secondary 01-1 groups, with preference at least 80% of secondary OH groups and with particular preference 90% of secondary OH groups. Particular preference is given to polyether polyols based on propylene oxide.

The polyols B) can also comprise fibres, fillers and polymers.

Crosslinking catalysts C) used can be the crosslinking catalysts known to the person skilled in the art, for example tertiary amines and organometallic compounds such as dibutyl tin dilaurate.

Particular preference is given to catalysts which also catalyse the trimerization reaction. Here again, these can be bases (tertiary amines, salts of weak acids, for example potassium acetate) and/or organometallic compounds. Trimerization catalysts initiate and accelerate the trimerization of isocyanate groups to give isocyanurate groups.

Additives D) can optionally be added. Examples of these are deaeraters, defoamers, fillers, flame retardants and reinforcing materials. It is possible if necessary to use other known additives and additions.

Flame retardants can further be added to the foamable preparations in order to improve fire-resistance, examples being phosphorus-containing compounds, especially phosphates and phosphonates, and also halogenated polyesters and polyols or chloroparaffins. It is moreover also possible to add non-volatile flame retardants such as melamine or expandable graphite, which expands greatly on exposure to flame and thus seals the surface, thus reducing further exposure to heat.

An example of a resin-infusion process into which the process of the invention can be integrated can be described as follows:

I. Provision of the raw materials for the PUR: the raw materials polyol component and isocyanate component and optionally other liquid substances are charged to separate containers. The raw materials are evacuated and degassed at a pressure of <50 mbar, especially <1 mbar. In order to improve degassing, the temperature of the raw materials, especially the polyol, can be increased (generally not above 80° C.). After degassing, the raw materials are cooled to usual room conditions, for example 23° C.

II. Preparation of the infusion system: the mould is provided, cleaned, and equipped with release agent, and optionally an “in-mould coating” is applied.

III. The infusion system is put in place. The system comprises:
Fibres (especially made from glass or CFP), laid fibre scrim, woven fibre fabric, etc.
Separator materials/cores (especially made from balsa wood, PVC, PET, PUR, etc.)
Other aids, such as hoses, clamps, flow aids, release films, etc.
Other technical assemblies, such as retention systems, lightning protection, etc.

IV. Vacuum-tight film and vacuum adhesive tape are used to seal the infusion system hermetically from the atmosphere.

V. The infusion system is connected to a vacuum unit and evacuated. The evacuation helps to ensure the correct positioning of the infusion constituents, to achieve an ideal proportion of fibre by volume, and to remove inclusions that are problematic during the infusion process, especially gases (air), thus preventing interruptions of flow.

VI. Conduct of the infusion process: the infusion system is connected to the metering machinery especially without any pressure rise (introduction of air). The infusion process generally takes place at room temperature. The infusion pressure should be above the pressure used to evacuate the raw materials (in order that no gas is evolved from the raw materials) and above the pressure used to evacuate the infusion system (in order that no gas is evolved from fibres, and especially from core materials). The metering machinery uses a mixing unit to mix the starting components in the prescribed mixing ratio and infuses the reaction product into the infusion system. As soon as the reaction mixture emerges from the filled mould, generally through a hose connection at the moulding end, the vacuum side (ex mould, in front of the vacuum pump) is sealed. The reaction mixture is charged from the metering machinery into the infusion system until flow of the said mixture, measurable by a continuous flow meter, has ceased. The maximal charging pressure to be used, pressure ex mixing unit, should be smaller than the prevailing atmospheric pressure (in order to avoid lifting of the film, pumping of excessive resin into the mould, alteration of the set proportion of fibre by volume, etc.). As soon as no more reaction mixture can be conveyed into the infusion system under these conditions, the “pressure side” (ex. mixing head) is sealed.

VII. Thermal post-treatment: after the infusion process, energy, especially heat, should be introduced into the infusion system in order to solidify the reaction product or in order to permit achievement of specific properties of the material, for example glass transition temperature. Heat-treatment can be achieved via external heating of the mould, for example in an oven, or via internal heating within the mould. By way of example, the heating can take place with a heating rate of +/−1° C. per minute.

VIII. Demoulding and downstream steps: after solidification of the reaction mixture the resultant component is removed from the mould. The production process is followed by subsequent steps such as grinding, repair of non-infused locations, final assembly and lacquering, etc.

The application of the superatmospheric pressure p2 according to the invention can take place between steps VI and VII in this list.

Embodiments of the present invention are described below. They can be combined with one another in any desired manner, unless the context clearly implies the opposite.

In one embodiment of the process of the invention, the molar ratio of isocyanate groups to OH groups in the polyurethane/polyisocyanurate reaction mixture is from 1.6 to 6.0. It is preferable that the NCO index is from 1.8 to 4.0 and particularly from 2.1 to 3.5.

The PIR conversion in the resultant polyisocyanurate is preferably above 20%, with preference above 40% and with particular preference above 60%. PIR conversion is the proportion of isocyanate groups reacted to give PIR. It can be detected via infrared spectroscopy.

In another embodiment of the process of the invention, the polyurethane/polyisocyanurate reaction mixture comprises a latently reactive trimerization catalyst, it is particularly preferable to use latently reactive trimerization catalysts which begin to initiate and to accelerate the trimerization of isocyanate groups to give isocyanurate groups only when the temperature reaches from 50 to 100° C.

It is preferable that the trimerization catalyst is a salt of a tertiary amine.

It is preferable here that the tertiary amine is selected from the group consisting of trimethylamine, triethylamine, tripropylamine, tributylamine, dimethylcyclohexylamine, dimethylbenzylamine, dibutylcyclohexylamine, dimethylethanolamine, triethanolamine, diethylethanolamine, ethyldiethanolamine, dimethyl isopropanolamine, triisopropanolamine, triethylenediamine, tetramethyl-1,3-butanediamine, N,N,N′,N′-tetramethylethylenediamine, N,N,N′,N′-tetramethylhexane-1,6-diamine, N,N,N′,N′,N″-pentamethyldiethylenetriamine, bis(2-dimethylaminoethoxy)methane, N,N,N′-trimethyl-N′(2-hydroxyethyl)ethylenediamine, N,N-dimethyl-N′,N′-(2-hydroxyethyl)ethylenediamine, tetramethylguanidine, N-methylpiperidine, N-ethylpiperidine, N-methylmorpholine, N-ethylmorpholine, 1,4-dimethylpiperidine, 1,2,4-trimethylpiperidine, N-(2-dimethylaminoethyl)morpholine, 1-methyl-4-(2-dimethylamino)piperidine, 1,4-diazabicyclo[2.2.2]octane, 1,8-diazabicyclo[5.4.0]undec-7-ene and/or 1,5-diazabicyclo[4.3.0]-5-nonane.

It is equally preferable that the salt is selected from the group consisting of phenolates, ethyl hexanoates, oleates, acetates and/or fox mates.

Surprisingly, it has been found that these latently reactive polyurethane (PUR) catalysts also catalyse the formation of polyisocyanurates (PIR) at elevated temperature.

Examples of commercially available latently reactive trimerization catalysts are Polycat® SA1/10 (phenol-blocked 1,8-diazabicyclo[5.4.0]undec-7-ene (=DBU)), Polycat® SA 102/10, DABCO® 8154 (formic-acid-blocked triethylenediamine) and DABCO® WT.

Particular preference is given, as trimerization catalyst, to 1,8-diazabicyclo[5.4.0]undec-7-ene, present in the form of phenolate salt, ethylhexanoate salt, oleate salt, acetate salt or formate salt.

In respect of the reaction mixture, preference is given to the combination of a glycerol-started polypropylene oxide polyol with a functionality of 3 and an OH number of from 350 to 450 mg KOH/g with the phenol salt of 1,8-diazabicyclo[5.4.0]undec-7-ene and MDI.

In another embodiment of the process of the invention the water content of the moulding core is from ≧(1.5% by weight to ≦30% by weight. It is preferable that the water content is from ≧4% by weight to ≦15% by weight. The simplest method for determining the water content is gravimetric: a wood sample is taken and immediately weighed. It is then dried at a temperature of 103±2° C. if possible in a ventilated oven to constant weight. Determination of the weight loss resulting from drying gives the quantity of water originally present in the wood. The details of the method are standardized in DIN 52183.

In another embodiment of the process of the invention the arrangement moreover has, on the moulding core, fibres and/or a textile sheet element, these being brought into contact with the polyurethane/polyisocyanurate reaction mixture. Materials that can be used for the fibres and/or the textile sheet element are sized or unsized fibres, for example glass fibres, carbon fibres, steel fibres or iron fibres, natural fibres, aramid fibres, polyethylene fibres or basalt fibres. Particular preference is given to glass fibres. The fibres can be used in the form of short fibres of length from 0.4 to 50 mm.

Preference is given to continuous-fibre-reinforced composite components resulting from the use of continuous fibres. The fibres in the fibre layer can have a unidirectional, irregularly distributed or woven arrangement. In components with a fibre layer made of a plurality of plies there is the possibility of ply-to-ply fibre orientation. It is possible here to produce unidirectional fibre layers, cross-laid layers or multidirectional fibre layers, where unidirectional or woven plies are mutually superposed. Particular preference is given to semifinished fibre products (sheet elements) such as woven fabrics, laid scrims, braided fabrics, mats, non-woven fabrics, knitted fabrics or 3D semifinished fibre products.

In order to ensure good saturation of the fibres, the reactive resin mixture should preferably be a low-viscosity liquid when it is charged to the system and remain a low-viscosity liquid for as long as possible. This is particularly necessary in the case of large components, since the charging time in these cases is very long (for example up to one hour). It is preferable that the viscosity of the reactive resin mixture of the invention at 25° C. directly after mixing is from 10 to 300 mPas, with preference from 20 to 80 mPas, with particular preference from 30 to 50 mPas. It is preferable that the viscosity of the reactive resin mixture of the invention at a constant temperature of 25° C. 30 minutes after the mixing of the components is less than 1000 mPas, particularly less than 500 mPas. Viscosity is determined 30 minutes after the mixing of the components at a constant temperature of 25° C. by using a rotary viscometer with a shear rate of 60 l/s.

In another embodiment of the process of the invention, the time t1 is from ≧5 minutes to ≦120 minutes, preferably from ≧10 minutes to ≦60 minutes. In another alternative embodiment, equally preferred, the time t1 can be from ≧45 minutes to ≦120 minutes.

In another embodiment of the process of the invention, the temperature T1 is from ≧20° C. to ≦50° C., preferably from ≧23° C. to ≦45° C.

In another embodiment of the process of the invention, the subatmospheric pressure p1 is from ≧0.1 mbar to ≦500 mbar, preferably from ≧0.5 mbar to ≦100 mbar.

In another embodiment of the process of the invention, the superatmospheric pressure p2 is from ≧1013 mbar to ≦10 bar, preferably from ≧1100 mbar to ≦5 bar, more particularly preferably from ≧5 bar to ≦10 bar.

The present invention is explained in more detail with reference to the following Figures and Examples, but is not restricted thereto.

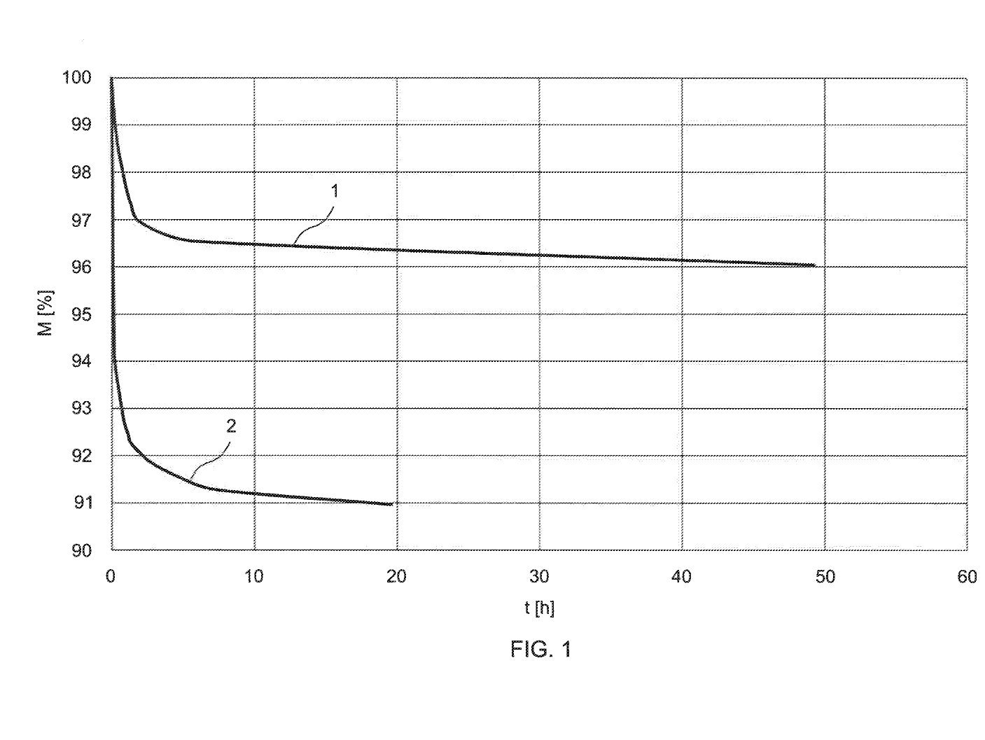

FIG. 1 shows drying curves of balsa wood in vacuo

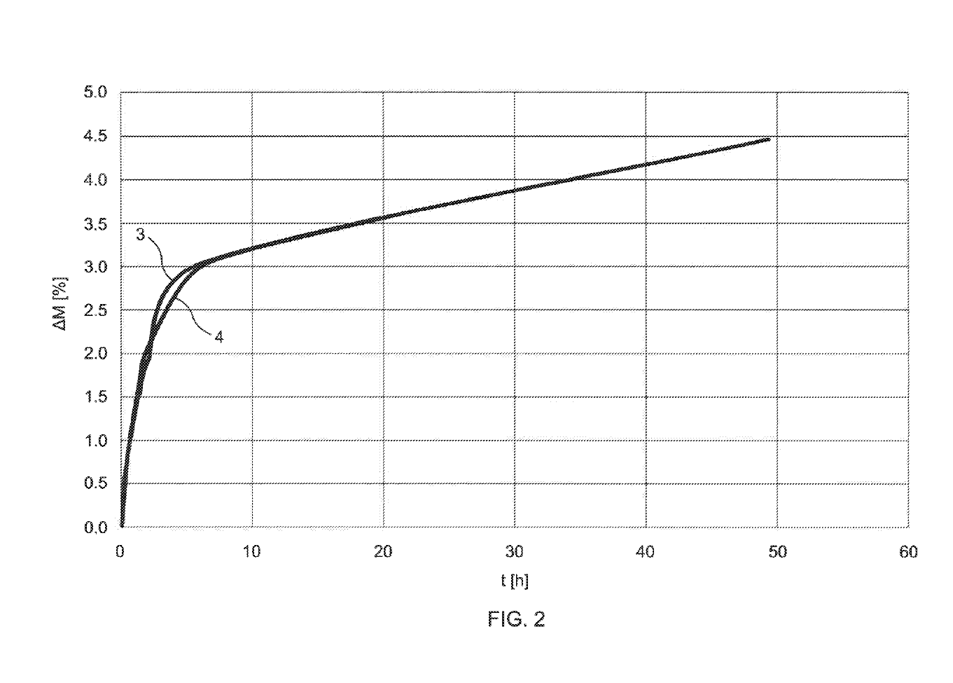

FIG. 2 shows weight increases of dried balsa wood due to atmospheric moisture

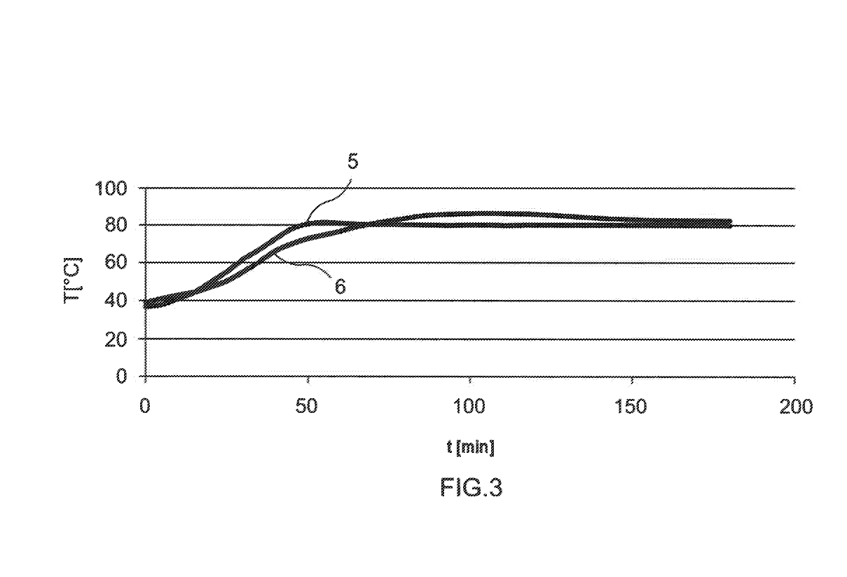

FIG. 3 shows the change in temperature in the interior of an infusion system over the course of time

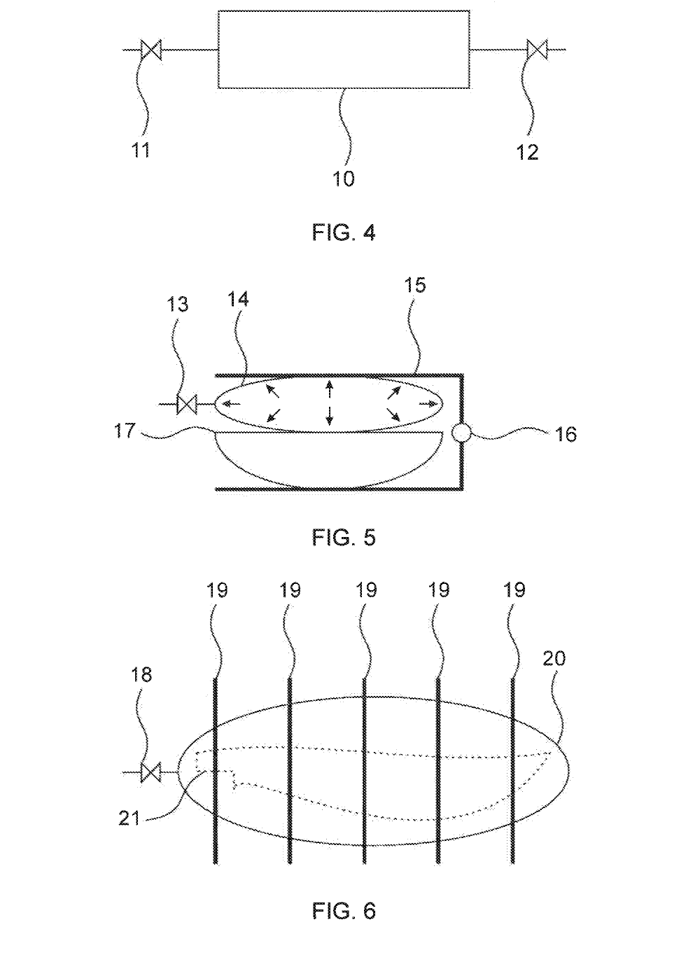

FIG. 4 shows an apparatus for carrying out the process

FIG. 5 shows another apparatus for carrying out the process

FIG. 6 shows another apparatus for carrying out the process

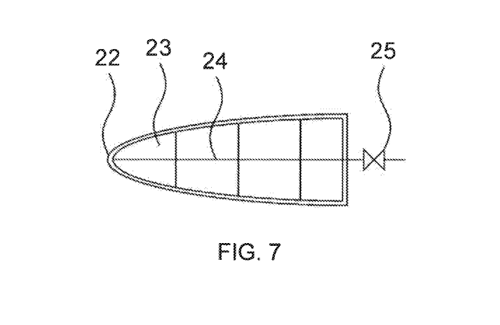

FIG. 7 shows another apparatus for carrying out the process

FIG. 1 shows the weight decrease of balsa wood samples due to drying in vacuo. The temperature at which the drying was carried out was 23° C. Curve 1 is the curve for 50 mbar, and curve 2 is the curve for 20 mbar. These experiments show how much water can be present in balsa wood.

FIG. 2 shows the absorption of moisture from the air by balsa wood samples that have previously been dried. Curve 3 relates to a sample previously dried at 20 mbar, and curve 4 relates to a sample previously dried at 50 mbar. These experiments show that it is not sufficient simply to subject balsa wood cores to one drying process in order to keep them free from water. They will reabsorb moisture from the ambient air.

FIG. 3 shows the change in temperature in the interior of an infusion system over the course of time. After the infusion process, the infusion system was positioned in an initially unheated oven. The oven was then heated at a heating rate of 1° C./min. Curve 5 gives the oven temperature and curve 6 gives the temperature of the infusion system. The resultant exothermic reaction is seen to increase the temperature of the system to somewhat above 80° C.

In one embodiment of the process of the invention, this is carried out in the interior of a closed mould. It is thus possible to carry out the process in existing RTM systems (resin transfer moulding systems). This is depicted diagrammatically in FIG. 4, which shows a corresponding apparatus. The location of the moulding core (optionally provided with fibres or with textile sheet elements) is in the interior of the mould 10. Sub- and superatmospheric pressure can be applied to the interior of the mould by way of valve 11. The polyurethane/polyisocyanurate reaction mixture can be introduced into the mould by way of valve 12.

In another embodiment of the process of the invention the superatmospheric pressure p2 is applied by means of a flexible container into which a fluid is introduced. The said container advantageously exerts pressure onto a mould within which is the location of the moulding core. The fluid can be a gas or a liquid. The pressure is thus passed onward onto the moulding core. An example here is shown in FIG. 5. A two-part mould 17 depicted diagrammatically comprises the lines provided for vacuum and polyurethane/polyisocyanurate reaction mixture (not depicted). An inflatable bag 14 is held in place by means of a clamp 15 which can be opened by way of a joint 16. Air is pumped into the bag 14 through valve 13. The bag 14 expands, and this is symbolized by the arrows located in the interior. Because the bag is held in place, the superatmospheric pressure prevailing in the bag is transferred to the mould 17 and thus to the moulding core.

FIG. 6 shows this variant in plan view for the production of a rotor blade for wind turbines. The location of a mould 21, depicted diagrammatically, is in the interior of an inflatable bag 20, and again here lines for vacuum and polyurethane/polyisocyanurate reaction mixture are not shown. The bag is held in place by a plurality of clamps 19 in the same way as FIG. 5 uses clamp 15. A pump can be used to inflate the bag 20 by way of valve 18.

In another embodiment of the process of the invention, the superatmospheric pressure p2 is applied by means of a flexible container into which a fluid is introduced, where the arrangement has a solid body in the interior of the flexible container. This variant is of interest to producers of rotor blades using one-shot technology for infusion. By way of example, a flexible tube can be drawn over a mandrel. The said mandrel is then introduced into the interior of two closed mould halves connected to one another, and the flexible tube is inflated by way of example by means of compressed air. An apparatus of this type is depicted in FIG. 7. A sealed flexible tube 22 has been drawn over a core 23 through which holes 24 pass. Compressed air can be introduced by way of valve 25. The compressed air emerges from the core 23 through the holes 24 and inflates the flexible tube 22.

### EXAMPLES

### Example 1

The production of some PIR polymers that can be used for the purposes of the present invention is described below. Mouldings (sheets) made of various polyisocyanurate systems were produced and compared here. The polyol mixtures comprising the trimerization catalyst were degassed for 60 minutes at a pressure of 1 mbar and then the isocyanate was admixed. This mixture was degassed for about 5 minutes at a pressure of 1 mbar and then cast in sheet moulds. The sheets were cast at room temperature and heat-conditioned overnight in an oven heated to 80° C. The thickness of the sheets was 4 mm. Optically transparent sheets were obtained. The quantitative data and properties can be found in the Table.

Test samples for a tensile test in accordance with DIN EN ISO 527 were produced from the sheets, and modulus of elasticity and strength were determined.

Heat Deflection Temperature (HDT) was determined in accordance with DIN EN ISO 75 1/75 2004—Method A with flexural stress 1.8 N/mm² and heating rate 120 K/h.

Viscosity was determined 30 minutes after mixing of the components at a constant temperature of 25° C. by using a rotary viscometer with a shear rate of 60 l/s.

### Starting Compounds:

Polyol 1: Glycerol-started polypropylene oxide polyol with a functionality of 3 and an OH number of 400 mg KOH/g and viscosity 375 mPas (at 25° C.).

Polycat® SA 1/10: Product of Air Products. Phenol salt of 1,8-diazabicyclo[5.4.0]undec-7-ene in dipropylene glycol. OH number was 83 mg KOH/g.

Isocyanate 1: Mixture of diphenylmethane 4,4′-diisocyanate (MDI) with isomers and higher-functionality homologues with NCO content 32.5% by weight; viscosity at 25° C.: 20 mPas. The mixture comprises about 51% by weight of diphenylmethane 4,4′-diisocyanate, 30% by weight of diphenylmethane 2,4′-diisocyanate, 6% by weight of diphenylmethane 2,2′-diisocyanate and 13% by weight of higher-functionality homologues of MDI.

Isocyanate 2: Mixture of diphenylmethane 4,4′-diisocyanate (MDI) with isomers and higher-functionality homologues with NCO content 32.6% by weight; viscosity at 25° C.: 20 mPas. The mixture comprises about 60% by weight of diphenylmethane 4,4′-diisocyanate, 22% by weight of diphenylmethane 2,4′-diisocyanate, 3% by weight of diphenylmethane 2,2′-diisocyanate and 15% by weight of higher-functionality homologues of MDI.

All of the quantitative data in Table 1 are stated in parts by weight.

| | Example 1 | Example 2 | Example 3 | Example 4 |
|---|---|---|---|---|
| Polyol 1 | 100 | 118 | 130 | 98 |
| Polycat SA1/10 | 2 | 2 | 2 | 2 |
| Isocyanate 1 | 300 | 280 | 268 | — |
| Isocyanate 2 | — | — | — | 300 |
| Molar NCO/OH ratio | 3.2 | 2.6 | 2.2 | 3.3 |
| Viscosity directly after | 34 | 45 | 49 | 49 |
| mixing at 25° C. [mPas] | | | | |
| Viscosity 30 min. after | 173 | 352 | 461 | 625 |
| mixing at 25° C. [mPas] | | | | |
| Tensile test: modulus of | 2966 | 2773 | 2819 | 2981 |
| elasticity [MPa] | | | | |
| Tensile test: strength | 80.9 | 83.7 | 83.5 | 79.7 |
| [MPa] | | | | |
| HDT [° C.] | 78 | 89 | 81 | 77 |

Examples 1 to 4 of the invention gave compact and optically transparent mouldings which combine very good mechanical properties such as modulus of elasticity above 2700 MPa, strength above 75 MPa and HDT value above 75° C. The production of fibre-reinforced components especially requires very low viscosity, since this permits markedly quicker and more uniform filling of the moulds. Shorter cycle times are thus possible, since required mould-occupancy times are shorter. The latently reactive trimerization catalyst used leads to very rapid hardening at 80° C.

### Example 2

Balsa wood samples measuring 1.5×3×0.8 cm with a 7.1% moisture content were in each case placed in a shell and covered with 300 g of the polyurethane reaction mixture according to the Example. The samples were then kept at a temperature of 23° C. for 45 min under a pressure p1 of 10 mbar. An elevated pressure p2 was then applied to the samples and the temperature was raised to 50° C. After the experiment an assessment was made of the optical quality of the samples and of foaming. Table 2 collates the experimental conditions and the results of the optical assessment of foaming.

| | | | Perceived optical |
|---|---|---|---|
| | Pressure [bar] | Reaction time [h] | quality |
| 1 | 1.013 (no pressure | 17 | Sample highly foamed |
| | applied) | | |
| 2 | 5.2 | 6 | Sample not foamed |
| 3 | 4.2 | 17.5 | Small number of |
| | | | bubbles in the sample, |
| | | | no foaming |
| 4 | 3.2 | 5 | Bubbles in the sample, |
| | | | slight foaming |
| 5 | 4.7 | 18 | No foaming |
| 6 | 4.7 | 5 | No foaming |

It was found that undesired foaming could be suppressed when the pressure p2 applied was 5 bar or greater.

The process of the invention therefore has excellent suitability for efficient production of high-quality rotor blades front a composite made of balsa wood, not necessarily predried, and a polyurethane reaction mixture.

1.-15. (canceled)

16. A process for the production of composite components, comprising the following steps:
providing a moulding core;
bringing at least one portion of the moulding core into contact with a polyurethane/polyisocyanurate reaction mixture, where at least for some time during the contact a subatmospheric pressure p1 is applied to at least the exterior of the moulding core;
wherein
a superatmospheric pressure p2 is applied to at least the exterior of the moulding core when
a time t1 has expired after beginning of the contact of the moulding core with the polyurethane/polyisocyanurate reaction mixture and/or
a temperature T1 is reached in the polyurethane/polyisocyanurate reaction mixture which makes contact with the moulding core.

17. The process according to claim 16, wherein the molar ratio of isocyanate groups to OH groups in the polyurethane/polyisocyanurate reaction mixture is from 1.6 to 6.0.

18. The process according to claim 16, wherein the polyurethane/polyisocyanurate reaction mixture comprises a latently reactive trimerization catalyst.

19. The process according to claim 18, wherein the trimerization catalyst is a salt of a tertiary amine.

20. The process according to claim 19, wherein the tertiary amine is selected from the group consisting of trimethylamine, triethylamine, tripropylamine, tributylamine, dimethylcyclohexylamine, dimethylbenzylamine, dibutylcyclohexylamine, dimethylethanolamine, triethanolamine, diethylethanolamine, ethyldiethanolamine, dimethylisopropanolamine, triisopropanolamine, triethylenediamine, tetramethyl-1,3-butanediamine, N,N,N′,N′-tetramethylethylenediamine, N,N,N′,N′-tetramethylhexane-1,6-diamine, N,N,N′,N′,N″-pentamethyldiethylenetriamine, bis(2-dimethylaminoethoxy)methane, N,N,N′-trimethyl-N′-(2-hydroxyethyl)ethylenediamine, N,N-dimethyl-N′,N′-(2-hydroxyethyl)ethylenediamine, tetramethylguanidine, N-methylpiperidine, N-ethylpiperidine, N-methylmorpholine, N-ethylmorpholine, 1,4-dimethylpiperidine, 1,2,4-trimethylpiperidine, N-(2-dimethylaminoethyl)morpholine, 1-methyl-4-(2-dimethylamino)piperidine, 1,4-diazabicyclo[2.2.2]octane, 1,8-diazabicyclo[5.4.0]undec-7-ene, and 1,5-diazabicyclo[4.3.0]-5-nonane.

21. The process according to claim 19, wherein the salt is selected from the group consisting of phenolates, ethylhexanoates, oleates, acetates, and formates.

22. The process according to claim 16, wherein the water content of the moulding core is from ≧0.5% by weight to ≦30% by weight.

23. The process according to claim 16, wherein a fibre and/or a textile sheet element on the moulding core is brought into contact with the polyurethane/polyisocyanurate reaction mixture.

24. The process according to claim 16, wherein the time t1 is from ≧5 minutes to ≦120 minutes.

25. The process according to claim 16, wherein the temperature T1 is from ≧20° C. to ≦50° C.

26. The process according to claim 16, wherein the subatmospheric pressure p1 is from ≧0.1 mbar to ≦500 mbar.

27. The process according to claim 16, wherein the superatmospheric pressure p2 is from ≧1013 mbar to ≦10 bar.

28. The process according to claim 16, wherein the process is carried out in the interior of a closed mould.

29. The process according to claim 16, wherein the superatmospheric pressure p2 is applied by means of a flexible container into which a fluid is introduced.

30. The process according to claim 16, wherein the superatmospheric pressure p2 is applied by means of a flexible container into which a fluid is introduced, and wherein a solid body is located in the interior of the flexible container.
